(19) United States
(12) Patent Application Publication
(10) Pub. No.: US 2013/0257356 A1
(43) Pub. Date: Oct. 3, 2013

(54) ELECTRONIC DEVICE HAVING CHARGING CURRENT SETTING UNIT AND CHARGING METHOD

(71) Applicants: AMBIT MICROSYSTEMS (SHANGHAI) LTD., Shanghai (CN); HON HAI PRECISION INDUSTRY CO., LTD., New Taipei (TW)

(72) Inventors: LIN-HAI TANG, Shanghai (CN); ZHI-FU GUO, Shanghai (CN)

(73) Assignees: HON HAI PRECISION INDUSTRY CO., LTD., New Taipei (TW); AMBIT MICROSYSTEMS (SHANGHAI) LTD., Shanghai (CN)

(21) Appl. No.: 13/848,059

(22) Filed: Mar. 21, 2013

(30) Foreign Application Priority Data
Mar. 27, 2012 (CN) 201210083487.5

(51) Int. Cl. H02J 7/00

(52) U.S. Cl. CPC H02J 7/0029; H02J 7/0052
USPC 320/107

(57) ABSTRACT

An electronic device includes a control unit, a battery and a charging current setting unit. The control unit is used to detect a DC voltage of a charger, compare the DC voltage with a predetermined charging voltage minimum, and output a current initializing signal and a current increasing signal to the charging current setting unit. The charging current setting unit is used to adjust a charging current according to signals generated by the control unit and output the adjusted charging current to the battery.

### BACKGROUND

1. Technical Field

The present disclosure relates to electronic devices, and more particularly to an electronic device capable of being charged by different types of chargers and a charging method of the electronic device.

2. Description of Related Art

Various kinds of rechargeable batteries used in electronic devices, such as e-books, mobile phones, smart computers, for example, need to be charged by suitable chargers. Generally, one type of charger is particularly suitable for a particular electronic device being charged by the charger. An electronic device is at risk of being damaged when the electronic device is charged by an unsuitable charger. Therefore, designing an electronic device, which can be suitable for different types of chargers, is a question for discussion.

Therefore, a need exists in the industry to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of function modules of one embodiment of an electronic device in accordance with the present disclosure.

FIG. 2 is a schematic diagram of functional modules of another embodiment of an electronic device in accordance with the present disclosure.

FIG. 3 is a flowchart of an embodiment of a charging method of an electronic device in accordance with the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

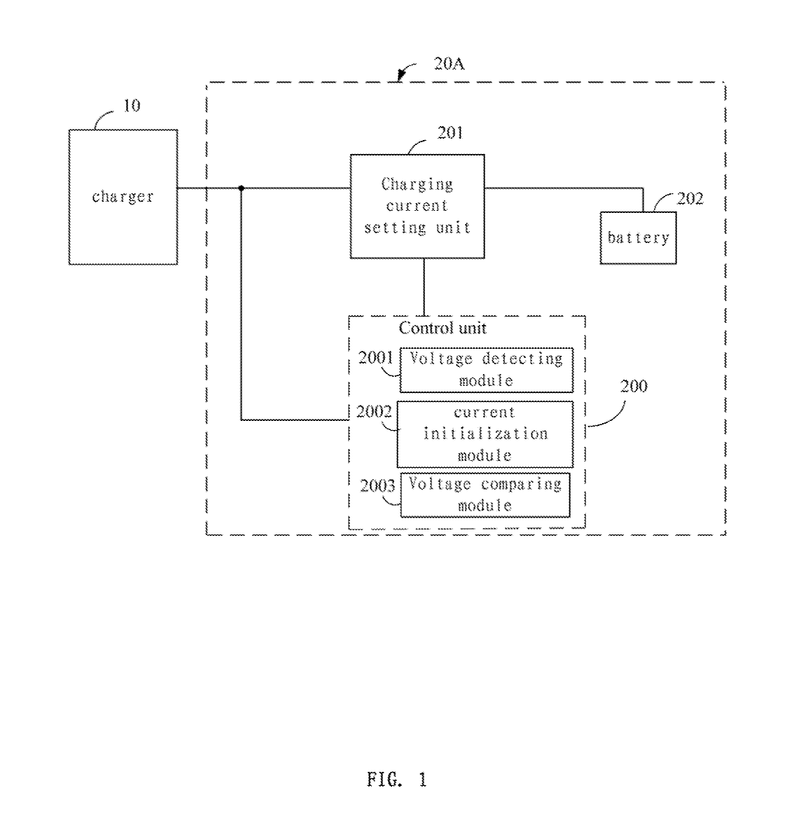

FIG. 1 is a schematic diagram of function modules of one embodiment of an electronic device 20A in accordance with the present disclosure. In one embodiment, the electronic device 20A may be an e-book, a mobile phone, a smart computer, for example. A charger 10 connected between a power supply (not shown) and the electronic device 20A is configured to provide a direct current (DC) voltage and a DC current for charging the electronic device 20A. The charger 10 has an output current rating, and in this embodiment, the output current rating is 1 A, but the disclosure is not limited thereto. A charging current minimum and a charging voltage minimum are predetermined for the electronic device 20A. The electronic device 20A is determined to be safe when the battery 202 is charged using current maintained at the charging current minimum. However, if the battery 202 is fully charged always using the current maintained at the charging current minimum completely, a longer charging time is needed. The charging voltage minimum is the minimum output DC voltage of the charger 20. The DC current output by the charger 10 is equal to or greater than the charging current minimum. The DC voltage output by the charger 10 is equal to or greater than the charging voltage minimum. In this embodiment, the charger 10 may be a USB charger, the current minimum of the electronic device 20A may be 300 mA, and the charging voltage minimum of the electronic device 20A may be 4.75V, for example.

In this embodiment, the electronic device 20A includes a control unit 200, a charging current setting unit 201 and a battery 202 used to power the electronic device 20A. The charging current setting unit 201 is electrically connected to the control unit 200 and the battery 202 to adjust a charging current according to signals generated by the control unit 200, thereby the battery 202 being charged by the adjusted charging current output from the charging current setting unit 201. The control unit 200 electrically connected to an output port of the charger 10 includes a voltage detecting module 2001, a current initialization module 2002 and a voltage comparing module 2003. The voltage detecting module 2001 is used to detect the DC voltage output by the charger 10 when the charger 10 is connected with the electronic device 20A. The current initialization module 2002 is used to generate a current initializing signal when the voltage detecting module 2001 detects the DC voltage of the charger 10 and outputs the current initializing signal to the charging current setting unit 201. Then, the charging current setting unit 201 outputs the charging current maintained at the charging current minimum to charge the battery 202.

The voltage comparing module 2003 is used to compare the DC voltage with the charging voltage minimum. If the DC voltage is greater than the charging voltage minimum, the voltage comparing module 2003 outputs a current increasing signal to the charging current setting unit 201. Then, the charging current setting unit 201 increases the charging current to charge the battery 202. If the DC voltage is less than the charging voltage minimum, the voltage comparing module 2003 outputs a current reducing signal to the charging current setting unit 201. Then the charging current setting unit 201 reduces the DC current to charge the battery 202. If the DC voltage is equal to the charging voltage minimum, the voltage comparing module 2003 fails to output any signals to the charging current setting unit 201, and the charging current setting unit 201 outputs the charging current maintained at the charging current minimum to charge the battery 202. In this embodiment, the current increasing signal is at high logic levels (logic 1), and the current reducing signal is at low logic levels (logic 0).

When the DC voltage detected by the voltage detecting module 2001 is greater than the charging voltage minimum, the charger 10 works in a normal state, that is, the DC current output by the charger 10 is less than the output current rating of the charger 10. In this state, the charging current setting unit 201 increases the charging current to charge the battery 202. The voltage detecting module 2001 continuously detects the DC voltage of the charger 10, and the voltage comparing module 2003 continuously compares the DC voltage with the charging voltage minimum.

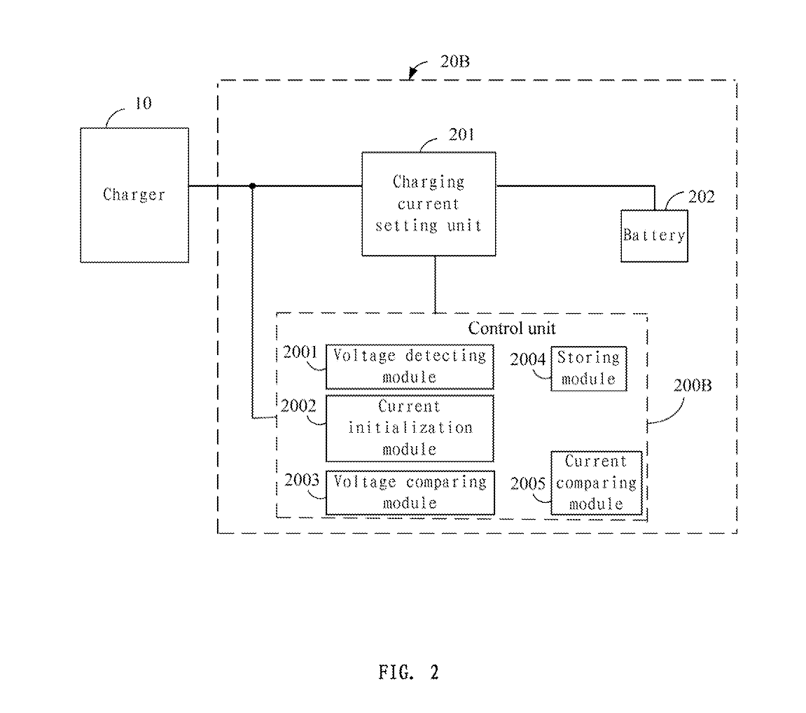

FIG. 2 is a schematic diagram of functional modules of another embodiment of an electronic device 20B in accordance with the present disclosure. The electronic device 20B includes a control unit 200B, a charging current setting unit 201 and a battery 202. Compared with the control unit 200 shown in FIG. 1, the control unit 200B of the electronic device 20B of this embodiment has an improved design. The control unit 200B includes features of the control unit 200, such as the voltage detecting module 2001, the current initialization module 2002 and the voltage comparing module 2003. The control unit 200B further includes a storing module 2004 and a current comparing module 2005. The storing module 2004 is used to store the charging current minimum, the charging voltage minimum and a charging current rating of the battery 202. The charging current rating of the battery 202 is a maximal charting current allowed to charge the battery 202. In this embodiment, the charging current rating of the battery 202 is 500 mA.

The current comparing module 2005 is used to compare the charging current output by the charging current setting unit 201 with the charging current rating of the battery 202, when the DC voltage is greater than the charging voltage minimum. If the charging current is equal to or greater than the charging current rating of the battery 202, the current comparing module 2005 outputs a rated current outputting signal to the charging current setting unit 201. The charging current output by the charging current setting unit 201 is adjusted to be about equal to the charging current rating of the battery 202. Therefore, the charging current is limited in an allowed range to protect the battery 202 and the electronic device 20B.

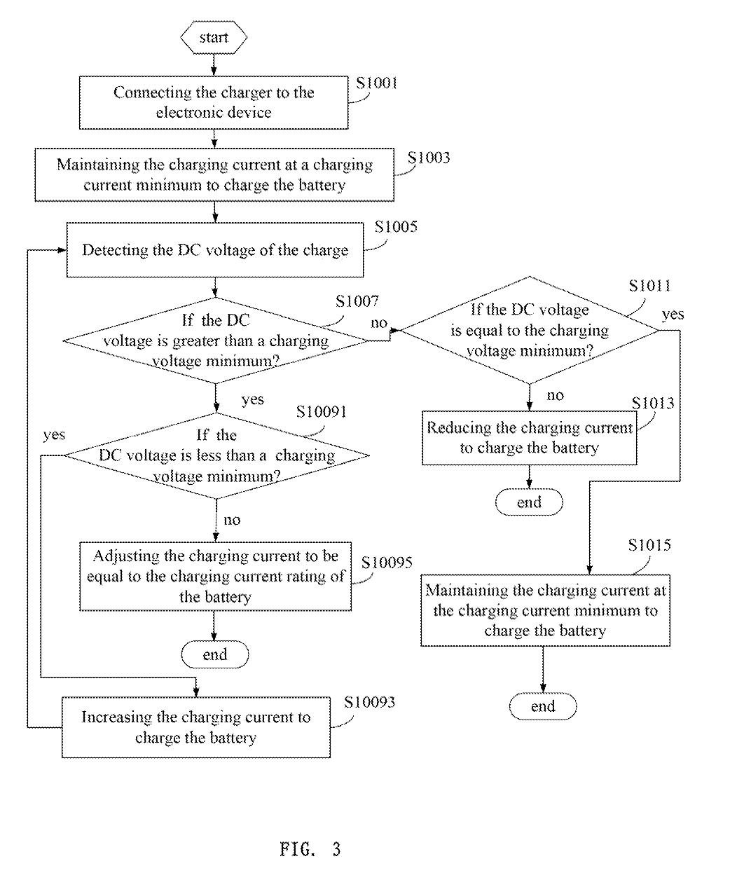

FIG. 3 is a flowchart of one embodiment of a charging method of the electronic device 20B shown in FIG. 2. In one embodiment, the electronic device 20B detects a type of the charger 10 and adjusts the charging current via the functional modules such as those of FIG. 2. Depending on the embodiment, additional blocks may be added, others deleted, and the ordering of the blocks may be changed while remaining well within the scope of the disclosure.

In block S1001, the charger 10 is connected between a power supply (not shown) and the electronic device 20A to provide the direct current (DC) voltage and the

DC current for charging the electronic device 20A. In this state, the voltage detecting module 2001 can detect the DC voltage output by the charger 10.

In block S1003, the charging current setting unit 201 outputs the charging current maintained at the charging current minimum to charge the battery 202.

In block S1005, the voltage detecting module 2001 detects the DC voltage of the charger 10.

In block S1007, the voltage comparing module 2003 compares the DC voltage with the charging voltage minimum.

If the DC voltage is greater than the charging voltage minimum, then in block S10091, the current comparing module 2005 compares the charging current output by the charging current setting unit 201 with the charging current rating of the battery 202.

If the charging current is equal to or greater than the charging current rating of the battery 202, then in block S10095, the current comparing module 2005 outputs a rated current outputting signal to the charging current setting unit 201, and the charging current output by the charging current setting unit 201 is adjusted to be equal to the charging current rating of the battery 202.

If the charging current is less than the charging current rating of the battery 202, then in block S10093, the voltage comparing module 2003 outputs a current increasing signal to the charging current setting unit 201, then the charging current setting unit 201 increases the charging current to charge the battery 202. Simultaneously, the electronic device 20A repeatedly performs the actions in the block S1005.

If the DC voltage is equal to or less than the charging voltage minimum, then in block S1011, the voltage comparing module 2003 compares the DC voltage with the charging voltage minimum.

If the DC voltage is less than the charging voltage minimum, then in block S1013, the voltage comparing module 2003 outputs a current reducing signal to the charging current setting unit 201, and the charging current setting unit 201 reduces the charging current to charge the battery 202.

If the DC voltage is equal to the charging voltage minimum, then in block S1015, the voltage comparing module 2003 fails to output any signals to the charging current setting unit 201, and the charging current setting unit 201 outputs the charging current maintained at the charging current minimum to charge the battery 202.

In conclusion, the electronic devices 20A, 20B detect the DC voltage of the charger 10 to give a judgment if the charger 10 works in a normal state. The electronic devices 20A, 20B dynamically adjust the charging current according to the judgment and charging capability of the charger 10. Therefore, the electronic devices 20A, 20B are suitable for different types of the chargers 10.

While various embodiments of the present disclosure have been described above, it should be understood that they have been presented using example and not using limitation. Thus the breadth and scope of the present disclosure should not be limited by the above-described embodiments, but should be defined in accordance with the following claims and their equivalents.

What is claimed is:

1. An electronic device, connected to a charger configured to provide a direct current (DC) voltage and a DC current for charging the electronic device, a charging voltage minimum and a charging current minimum being predetermined for the electronic device, the electronic device comprising:
a control unit, comprising:
a voltage detecting module electrically connected to the charger and detecting the DC voltage;
a current initialization module outputting a current initializing signal when the voltage detecting module detects the DC voltage; and
a voltage comparing module comparing the DC voltage with the charging voltage minimum and outputting a current increasing signal if the DC voltage is greater than the charging voltage minimum;
a battery, powering the electronic device; and
a charging current setting unit electronically connected to the control unit and the battery, adjusting a charging current according to signals generated by the control unit and outputting the adjusted charging current to the battery, to output the charging current maintained at the charging current minimum when the charging current setting unit receives the current initializing signal, and to increase the charging current when the charging current setting unit receives the current increasing signal.

2. The electronic device of claim 1, wherein the control unit further comprises a current comparing module comparing the charging current output by the charging current setting unit with a charging current rating of the battery, and outputting a rated current outputting signal to the charging current setting unit if the charging current is equal to or greater than the charging current rating, wherein the charging current output by the charging current setting unit is adjusted to the charging current rating.

3. The electronic device of claim 2, wherein the control unit further comprises a storing module storing the charging current minimum, the charging voltage minimum, and a charging current rating.

4. The electronic device of claim 1, wherein the voltage comparing module outputs a current reducing signal to the charging current setting unit, and the charging current setting unit reduces the DC current, if the DC voltage is less than the charging voltage minimum.

5. A charging method, used to adjust a charging current to charge a battery of an electronic device by a charger, comprising:
predetermining a charging voltage minimum and a charging current minimum for the electronic device;
detecting a DC voltage of the charger in response to the charger being connected to the electronic device;
comparing the DC voltage with the charging voltage minimum to determine if the DC voltage is greater than the charging voltage minimum;
outputting a current increasing signal and increasing the charging current if the DC voltage is greater than the charging voltage minimum; and
repeatedly detecting the DC voltage of the charger.

6. The charging method of claim 5, further comprising:
determining if the DC voltage is equal to the charging voltage minimum when the DC voltage is not greater than the charging voltage minimum; and
reducing the charging current to charge the battery if the DC voltage is less than the charging voltage minimum.

7. The charging method of claim 6, wherein the charging current is maintained at the charging current minimum to charge the battery if the DC voltage is equal to the charging voltage minimum.

8. A charging method, used to adjust a charging current to charge a battery of an electronic device by a charger, comprising:
predetermining a charging voltage minimum and a charging current minimum for the electronic device;
detecting a DC voltage of the charger in response to the charger is connected to the electronic device;
comparing the DC voltage with the charging voltage minimum to determine if the DC voltage is greater than the charging voltage minimum;
determining if the DC voltage is less than the charging voltage minimum, when the DC voltage is greater than the charging voltage minimum;
increasing the charging current to charge the battery, if the DC voltage is less than the charging voltage minimum; and
repeatedly detecting the DC voltage of the charger.

9. The charging method of claim 8, further comprising:
determining if the DC voltage is equal to the charging voltage minimum when the DC voltage is not greater than the charging voltage minimum; and
reducing the charging current to charge the battery if the DC voltage is less than the charging voltage minimum.

10. The charging method of claim 9, wherein the charging current is maintained at the charging current minimum to charge the battery if the DC voltage is equal to the charging voltage minimum.
